(19) United States
(12) Patent Application Publication
(10) Pub. No.: US 2004/0230568 A1
(43) Pub. Date: Nov. 18, 2004

(54) Method of searching information and intellectual property

(76) Inventor: Ludomir A. Budzyn, Maplewood, NJ (US)

Correspondence Address: Ludomir A. Budzyn, 7 Edgewood Place, Maplewood, NJ, 07040, US

(21) Appl. No.: 10/695,217

(22) Filed: Oct. 28, 2003

Related U.S. Application Data
(60) Provisional application No. 60/421,710, filed on Oct. 28, 2002.

(51) Int. Cl. G06F 17/30

(52) U.S. Cl. 707/3

(57) ABSTRACT

A method is provided which relates various forms of information, for example, trademark information with patent information, to investigate intellectual property relating to a product, an entity and/or trademark, and, optionally, other information relating to same. In particular, the method relies on certain bits of information which are used to establish search criteria. In one exemplary use, using known computing technology, a searcher will simply input a product's trademark, and one or more lists of relevant patents can be generated, preferably arranged in a hierarchy of importance, along with other relevant information.

### CROSS-REFERENCE TO RELATED APPLICATION

This application claims priority to U.S. Provisional Appl. No. 60/421,710, filed Oct. 28, 2002.

### BACKGROUND OF THE INVENTION

Intellectual property databases, particularly Internet-based databases, are known and used quite widespreadly. Techniques have been developed to search the Internet for intellectual property infringers (see, e.g., U.S. Pat. No. 6,289,341 B1, which issued on Sep. 11, 2001 to Barney; U.S. Published Patent Appl. No. 2001/0041989 which published on Nov. 15, 2001 to Vilcauskas, Jr. et al.; and, U.S. Published Patent Appl. No. 2002/0152261 A1, which published on Oct. 17, 2002 to Arkin et al.), and to search for prior art and patent-related literature (see, e.g., U.S. Published Patent Appl. No. 2001/0027452 which published on Oct. 4, 2001 to Tropper; U.S. Published Patent Appl. No. 2002/0042784 which published on Apr. 11, 2002 to Kerven et al.; U.S. Published Patent Appl. No. 2002/0138465 which published on Sep. 26, 2002 to Lee; U.S. Published Patent Appl. No. 2002/0138474 which published on Sep. 26, 2002 to Lee; U.S. Published Patent Appl. No. 2002/0138475 which published on Sep. 26, 2002 to Lee; and, U.S. Published Patent Appl. No. 2002/0147738 which published on Oct. 10, 2002 to Reader). Computer-based techniques have also been developed to manage intellectual property for analysis and other purposes, such as proper patent marking (see, e.g., U.S. Published Patent Appl. No. 2002/0035571 which published on Mar. 21, 2002 to Coult; U.S. Published Patent Appl. No. 2002/0082890 which published on Jun. 27, 2002 to Bracchitta et al.; and, U.S. Published Patent Appl. No. 2002/0138297 which published on Sep. 26, 2002 to Lee).

Separately, competitors in business often seek to copy (i.e., “knock off”) each other's commercialized products, particularly commercially-successful products. Prior to doing so, a prudent manufacturer evaluates what protection, if any, a competitor may have for a particular product to consider its possible liability before copying a product. Typically, the most onerous obstacle for a competitor to overcome in avoiding liability for product-copying is intellectual property (patents; trademarks; etc.). For example, in the prior art, where a party is interested in determining whether or not a commercialized product is protected by any patents, a patent search is done of the patents owned by all parties commercializing the product, and each of the patents is compared to the commercialized product to determine its relevance. As is readily apparent, this is a time-consuming and, often, expensive task. This analysis is often made even more difficult since it may require some effort to identify the parties that may be involved in a product's commercialization (e.g., distributor(s); manufacturer(s); technology and/or intellectual property licensor(s)). It should also be noted that the titles of patents, as well as the rest of the patents (abstract, specification, claims), are typically written in “legalese” which bear no connection to the product's tradename or trademark, and, thus, the text of the patents cannot be relied upon to ascertain quickly which patents are relevant.

These analyses can be simplified where a product is marked with a patent number, thereby giving a searcher a definite starting point for conducting a search. Although the law provides benefits to patentees who properly mark their products with relevant patent numbers, many products are not marked with a patent number, and, moreover, there is no requirement to mark products covered by certain patents (e.g., products prepared by process/method patents).

To further complicate this analysis, “industry” people in a particular field will refer to a product by its tradename or trademark—these names or terms being often unfamiliar to the legal personnel conducting the intellectual property investigation since those persons typically have little or no first-hand knowledge of the industry (e.g., a patent attorney who works at a law firm). Thus, an inquiry (which is fairly commonplace) as to whether or not a company can copy a competitor's “GADGET” brand widget will involve not only an investigation of what intellectual property is owned by the company behind the widget, but also an investigation into what is a “GADGET” brand widget.

An even further complication is that companies often do business under a tradename, or under a company's parent name, while intellectual property may be held in the name of an affiliated company (e.g. wholly-owned subsidiary) for tax or other purposes. Thus, in the commercial marketplace, the company that is perceived as commercializing a product may have a legal name which is not known, and/or is not the owner of record of the intellectual property in question. For example, an inquiry may be made as to whether XYZ Co. has any patents related to the “GADGET” brand widget. XYZ Co. may be a tradename of a corporation which is legally named ABC Corp., and thus any search under XYZ will not turn up any patents or trademarks. Alternatively, XYZ Co. may be the parent corporation of different wholly-owned subsidiaries, with each of the subsidiaries owning intellectual property, and no intellectual property being owned by XYZ Co. (e.g., the ABC Widget Division of XYZ Co. owns widget-related intellectual property and a search of XYZ will not uncover any related information). Thus, thorough searching of XYZ Co.'s intellectual property may also require searching of XYZ Co.'s corporate structure and affiliations.

The above-mentioned techniques disclosed in the prior art are not capable of investigating intellectual property to overcome the discussed problems, and it is an object of the subject invention to provide an inventive method of searching and investigating intellectual property and other information related to a product, entity, and/or trademark.

### SUMMARY OF THE INVENTION

The aforementioned object is met by a new inventive method which relates various forms of information, for example, trademark information with patent information, to investigate intellectual property relating to a product, an entity and/or trademark, and, optionally, other information relating to same. In particular, the method relies on certain bits of information which are used to establish search criteria. In one exemplary use, using known computing technology, a searcher will simply input a product's trademark, and one or more lists of relevant patents can be generated, preferably arranged in a hierarchy of importance, along with other relevant information.

For illustrative purposes, the discussion herein will refer to U.S. patents and trademarks. Those skilled in the art will easily understand the applicability of the invention to other jurisdictions (e.g., Europe; Canada; Japan) and to other information (e.g., company structure; litigation history). In addition, the subject invention is well-suited to be practiced on a computer, particularly over a network of computers (global (e.g., Internet); local). It is also to be understood that reference herein to “trademarks” shall be to all forms of trademarks including but not limited to trademarks which are related to goods, service marks, collective marks, and certification marks.

These and other aspects of the subject invention shall be better understood through a study of the following detailed description and accompanying drawings.

### BRIEF DESCRIPTION OF THE DRAWINGS

FIG. 1 is a flowchart of an exemplary method practiced in accordance with the subject invention;

FIG. 2 is a flowchart of a preferred arrangement of queries utilizable in the method of FIG. 1; and,

FIGS. 3-5 are schematics representing possible arrangements of search results.

### DETAILED DESCRIPTION OF THE INVENTION

With the subject invention, certain data is inputted which results in one or more search(es) of intellectual property database(s), such as database(s) of trademarks (e.g., registered trademarks or applications to registers trademarks). Upon identifying intellectual property which match predetermined search criteria, a search of a second intellectual property database may be conducted. In addition, secondary search(es) may be conducted of additional informational database(s) and/or computer network(s) (local or global (e.g., Internet)). With one or more secondary searches, specific information relating to the original data input may also be uncovered.

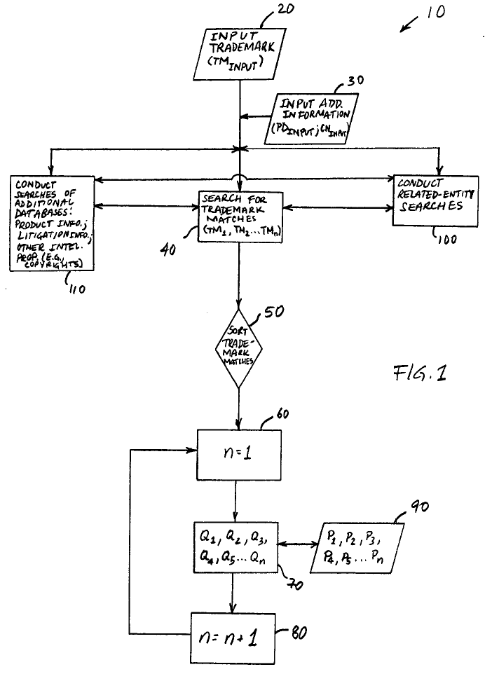

By way of non-limiting example, and with reference to FIG. 1, a method of identifying patents relating to a reference trademark is depicted therein and generally designated with the reference numeral 10. The method can be applied to other forms of intellectual property (e.g., copyrights) and may be used in reverse (uncover trademarks relating to a patented product). To illustrate the subject invention, the operation of the invention will be described in conjunction with an inquiry to uncover patents relating to “GADGET” brand widgets of XYZ Co.

Initially, a searcher will input a reference trademark (TM_{INPUT}), such as “GADGET”, used in conjunction with the product in question into a search program (Box 20). Preferably, all of the steps described herein shall be conducted over computing processing units (CPU's), such computing being performed on a single CPU or split up over several CPU's (e.g., networked). Additional information may also be inputted besides the inputted reference trademark (TM_{INPUT}) (Box 30). For example, the product description (PD_{INPUT}) (such as a widget) and the name of the entity selling the product (CN_{INPUT}) (such as XYZ Co.) may be inputted.

Using any technique known to those skilled in the art, a search engine will search one or more trademark database(s) (which can include Federal registered trademarks and applications to register trademarks; state registered trademarks and applications to register trademarks; industry/trade databases and other databases which may include common law and unregistered trademarks) for trademark matches (TM₁, TM₂, . . . TMₙ) to the inputted trademark (TM_{INPUT}) (Box 40). A trademark match (TM₁, TM₂, . . . TMₙ) may be defined in various manners: for example, a match may be defined as a trademark which is an identical match (i.e., a trademark match must identically match the inputted reference trademark); and/or, as a trademark which includes a term in common with the inputted reference trademark (e.g., the database may include a graphic trademark logo including a term common with the inputted reference trademark (e.g., a graphic logo with the word “GADGET”), or the database may include a composite word mark which includes the inputted reference trademark amongst other terms (e.g., “DOING IT BETTER WITH GADGET”)). Likewise, the inputted reference trademark (TM_{INPUT}) can be parsed prior to searching and each of the parsed terms can be used to identify trademark matches (TM₁, TM₂, . . . TMₙ) in one or more of the manners described above.

With trademark databases, certain characteristics of the trademarks of the database are maintained. Preferably, characteristics associated with each of the trademark matches (TM₁, TM₂, . . . TMₙ) are determined in the relevant database, associated with the relevant trademark match (TM₁, TM₂, . . . TMₙ), and preferably saved (at least temporarily); by way of non-limiting example, the following characteristics can be used: the owner of the relevant trademark match (ONₙ); dates of first use (Dₙ); goods/services description (GSₙ); and, trademark classification (Cₙ) (which can be the International Classification(s) and/or the U.S. Classification(s)).

Once the characteristics of the trademark matches (TM₁, TM₂, . . . TMₙ) have been determined, and although not necessary to practicing the invention, it is preferred that the trademark matches (TM₁, TM₂, . . . TMₙ) be sorted into an hierarchical order of relevance based on best to least matches to the initial inputted information (TM_{INPUT}; PD_{INPUT}; CN_{INPUT}) (Box 50). For example identical trademark matches can be ranked higher than non-identical trademark matches. In addition, the additional initial input (PD_{INPUT}; CN_{INPUT}) can be relied on in sorting the hierarchy of trademark matches based on “best fit” methodology (e.g., the additional initial input (PD_{INPUT}; CN_{INPUT}) can be compared to the characteristics (ONₙ, Dₙ, GSₙ; Cₙ) associated with each of the trademark matches; thus, two uncovered “GADGET” trademarks, although identical to the inputted reference trademark and equally ranked as being identical matches, may be distinguished by evaluating the additional input (PD_{INPUT}; CN_{INPUT}) and associated characteristics (ONₙ, Dₙ, GSₙ; Cₙ) to determine closeness between the two). As a result of the sorting step, the trademark matches can be re-numbered from most to least relevant (i.e., the most relevant trademark match becomes TM₁, the second-most relevant TM₂, and so forth).

The trademark matches (TM₁, TM₂, . . . TMₙ), preferably in hierarchical order from most to least relevant, are subsequently processed in sequence to produce discrete sets of results associated with each trademark match. For such processing, an initial value (Box 60) is set to initiate the searching, preferably with the most relevant trademark match (after sorting, TM₁) and subsequent trademark matches (TM₂, . . . TMₙ) are taken in turn. For each of the matched trademarks, the associated trademark characteristics (ONₙ, Dₙ, GSₙ; Cₙ) are converted into at least one query, preferably a series of search queries, which is inputted into one or more patent databases (Box 70). A counter (Box 80) initiates the searching for the subsequent trademark matches (TM₂, . . . TMₙ). The search queries not only involve databases of issued patents, but may also involve databases of published patent applications, both in the U.S. and abroad. Reference herein to “patents” is generally to any patent literature.

Preferably, a first query (Q₁) is generated wherein patents in which rights are owned by the owner (ONₙ) of the relevant trademark match are uncovered and identified as a first set of results (P₁)(Box 90). By way of non-limiting example, the first query (Q₁) may be conducted with the name of the owner (ONₙ) of the relevant trademark match being parsed, and Boolean operators used to conduct searches with the parsed terms. For example, the first query (Q₁) can search for patents assigned to XYZ Co. Most patent databases include fields of bibliographic information associated with each patent, and assignee information is typically included in such bibliographic information. Preferably, the first query (Q₁) is limited to searching the bibliographic information, particularly the assignee field. The first query (Q₁) may also include searches of the entire assignment history to not only check the assignee-at-issue of the patents (P₁), but also post-issuance assignees. It is important to note that assignee information specified on the face of a patent is voluntarily provided by the patentee and not checked by the U.S. Patent Office. Thus, even if a patent on its face appears unassigned, it may be assigned. A check of the assignment records can uncover patents which may not be identified in merely checking the “front page” information of patent databases.

Searches may also be conducted of other informational databases to evaluate rights other than by assignment, such as licenses, with any such uncovered patents also being included in the first set of results (P₁). Although patent licenses do not have to be formally recorded with the U.S. Patent Office (like assignments), some companies issue press releases regarding patent licenses, and, occasionally, patent licenses are reported in public filings/disclosure documents, such as SEC filings. Accordingly, the first query (Q₁) may search not only patent databases, but also news, business, financial, and the like, databases, to uncover relevant patents. As contemplated herein, the first query (Q₁) may uncover patents in which any rights are owned.

Besides the owner name (ONₙ) of the relevant trademark match (TMₙ), the first query (Q₁) may also involve the inputted company name (CN_{INPUT}). In this manner, patents may be uncovered in the name of the inputted company (CN_{INPUT}), if different from the owner name (ONₙ) of the relevant trademark match (TMₙ). The subset of the first results (P₁) corresponding to the owner name (ONₙ) may be considered more relevant than the subset of results based on the inputted company name (CN_{INPUT}) and arranged correspondingly in hierarchical fashion.

In conducting the first query (Q₁), it is preferred that non-identical names also be identified and used in searching. Terms such as “corporation”, “incorporated”, “company” and variations thereof, may be parsed out of the search query, since such information may be slightly inconsistent between databases. The focus is preferably on the core of the owner name (ONₙ; CN_{INPUT}). For example, the “XYZ” of XYZ Co. is the core name and should be the focus of the first query (Q₁).

As a second query (Q₂), the description of goods/services (GSₙ) of the relevant trademark match and/or the inputted product description (PD_{INPUT}) are applied to identify patents (P₂) which may relate to the goods/services of the relevant trademark match and/or the inputted product description (PD_{INPUT}). By way of non-limiting example, the second query (Q₂) can be conducted by parsing the description of the relevant goods/services (GSn: PD_{INPUT}) and using known Boolean operators to conduct full-text searches of the patents. For example, the term “widget” can be used to search the full texts of the patents. Dictionaries and/or thesauruses may be applied to the parsed terms to expand searching thereof. As such, alternative terms, homonyms, and so forth may be searched. For example, a search for the term “syringe” may also require searching for “needle”, “cannula”, and the like.

Optionally, even further queries (Q₃, Q₄ . . . Qₙ) can be conducted. For instance, a third query (Q₃) may involve comparing the relevant trademark's date of first use (Dₙ) with the filing dates and priority dates of the patents. Here, patents filed, and/or having a priority date, less than one year prior to the trademark's dates of first use (Dₙ) and earlier may be identified (in other words, patents filed, and/or having a priority date, more than one year after the date of first use may be excluded). Under United States Patent Law, a party is given one year to practice their invention before filing for patent protection. As a result, a substantial number of patent filings occur before the one-year statutory bar expires. A fourth query (Q₄) may involve cross-referencing the classification (Cₙ) of the relevant trademark match against US patent classifications to identify a fourth set of patents (P₄). In this manner, a rough sorting of patents can be done. For example, the classification (Cₙ) of the relevant trademark match (e.g., widgets) can be compared against U.S. Patent classes relating to widgets to determine which patents fall in those classes.

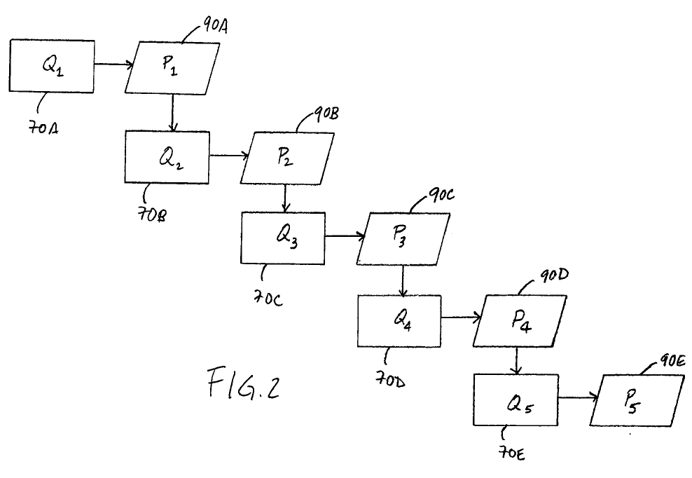

With reference to FIG. 2, it is preferred that the queries (Q₁-Q₄) be performed in sequence to previously-uncovered results (P₁-P₄), such that the uncovered patents may be separated into a hierarchy of relevant patents. For example, the second query (Q₂) may be applied to the first results (P₁), the third query (Q₃) may be applied to the second results (P₂), and so on, such that the results of the last query (which may be the fourth query (Q₄)) would theoretically provide the most-relevant results, the penultimate query (e.g., Q₃) would provide the second most-relevant results, and so forth. If used in sequence, and a query produces no results, any previously-uncovered patents should be carried over; e.g., the second results (P₂) can be made equal to the third results (P₃). FIG. 2 depicts a preferred sequence of the first-fourth queries (Q₁-Q₄) (Boxes 70A-D) producing the first-fourth sets of results (P₁-P₄) (Boxes 90A-D). As will be readily recognized by those skilled in the art, any number and any sequence of the queries (Q₁-Q₄) may be utilized.

As a further query (Q₅), additional patents (P₅) naming one or more of the inventors of any of the results (P₁-P₄) may be uncovered (Boxes 70E and 90E). Commonly, inventors who have invented in a particular area do so with some regularity. By searching for patents in the name(s) of the inventor(s) of uncovered patents, other relevant patents may be uncovered which fell outside the initial queries (Q₁-Q₄). For example, an assignment of a patent may have been improperly recorded by the U.S. Patent Office, failing to show that a patent is properly owned by XYZ Co. However, it may include one or more of the same inventors of an uncovered patent. Preferably, the fifth query (Q₅) is only applied to the most relevant search results (e.g., P₄). In addition, other criteria can be used to limit the fifth query (Q₅) such as also using the inventors' address information to increase the probabilities that the same inventors are involved with any uncovered patents.

In addition, or alternatively, to the sequential processing, the queries (Q₁-Q₅) may be applied to the general patent databases separately, in whole or in part. In this manner, patents may be uncovered if the earlier queries have no results. Also, the queries can act as redundant checks against each other to best ensure relevant patents are uncovered.

Other searches may be conducted using the inputted information (TM_{INPUT}; PD_{INPUT}; CN_{INPUT}), as well as, possibly the characteristics of the trademark matches (TM₁, TM₂, . . . TMₙ). For example, a search may be conducted to uncover entities related to the inputted owner information (CN_{INPUT}) and/or to the owner information (ONₙ) uncovered with any of the trademark matches (TM₁, TM₂, . . . TMₙ) (Box 100). These searches can be conducted in any corporate or financial database, such as Dun & Bradstreet. Any entities uncovered related to the inputted owner information (CN_{INPUT}) (e.g., wholly-owned subsidiaries; divisions; sister companies; etc.) can be used to update the inputted owner information (CN_{INPUT}) to include the uncovered related entities. As a result, any searches using the updated inputted owner information (CN_{INPUT}), (e.g., the search for trademark matches (TM₁, TM₂, . . . TMₙ); the first query (Q₁); and so on) would be of both the original information and the added related-entity information. Furthermore, related-entity search(es) can be done of the owner names (ONₙ) of the trademark matches (TM₁, TM₂, . . . TMₙ) (Box 100). Accordingly, the owner name information (ONₙ) can be updated to include any related entities and the first query (Q₁) would search not only for patents owned by the actual owner of the trademark match, but also to related entities. For example, XYZ Co. may be uncovered as an owner of a trademark match. With a search of related entities, DEF Co. is uncovered as a wholly-owned subsidiary of XYZ Co. The owner information (ONₙ) for the trademark match may be updated to not only include XYZ Co., but also DEF Co. Accordingly, the first query (Q₁) is conducted to uncover patents in which XYZ Co. and/or DEF Co. have rights and associate those patents with the relevant trademark match.

Optionally, the names of any individuals identified in the related-entity searching (e.g., officers; directors; employees) may be used in conducting inventor searches to uncover potentially-relevant patents. Often, particularly with small and mid-size companies, principals play a large role in running the company day-to-day, including being involved in inventing, marketing, and product development.

The initial inputted information (TM_{INPUT}; PD_{INPUT}; CN_{INPUT}) and/or the associated trademark characteristics (ONₙ, Dₙ, GSₙ, Cₙ) of the uncovered trademark matches (TM₁, TM₂, . . . TMₙ) may also be used to conduct search(es) of additional databases, such as: litigation databases (including databases of reported court decisions; and/or, the US Court electronic docketing system (PACER)); and/or, other intellectual property databases (e.g., copyright databases)(Box 110). By searching litigation databases, litigations may be uncovered involving the inputted owner (CN_{INPUT}), the owner (ONₙ) of any of the trademark matches, and/or entities related thereto (obtained by searching for related entities, as discussed above). The results of the litigation-related searches may be ranked for relevance by establishing certain criteria. For example, litigations involving any of the relevant parties can be ranked higher than others; litigations involving one or more of the inputted terms (e.g., TM_{INPUT}; PD_{INPUT}), the trademark match (TMₙ) and/or one or more of the trademark match characteristics (e.g, GSₙ) may be considered more relevant than other cases: and/or, litigations involving intellectual property can be ranked higher than non-intellectual property cases (intellectual property cases can be identified by searching for the terms “patent”, “trademark”, “copyright”, “trade secret” and the like in the litigation records; and/or, by reviewing classification numbers of the litigation, such as the U.S. Federal NOS (Nature of Suit) numbering system—e.g., copyright cases are assigned the number 820; patent cases are assigned the number 830; and trademark cases are assigned the number 840).

Other intellectual property may be searched to uncover properties in which rights are owned by the inputted owner (CN_{INPUT}), the owner (ONₙ) of any of the trademark matches, and/or entities related thereto. For example, copyright registrations can be searched and identified (such as by searching the database maintained by the Library of Congress, accessible through www.loc.gov). The copyright registrations can be ranked by relevance by reviewing the uncovered registrations using the inputted information (TM_{INPUT}; PD_{INPUT}; CN_{INPUT}) and/or characteristics of the trademark matches (ONₙ, Dₙ, GSₙ, Cₙ). In this manner, a copyright registration owned by XYZ Co. can be identified and its relevance evaluated by determining if it relates to widgets. For example, a textual copyright registration owned by XYZ Co. relating to the instructions manual for use with a “GADGET” widget can be judged to have a high degree of relevance.

The inputted information (TM_{INPUT}; PD_{INPUT}; CN_{INPUT}) and/or trademark-match characteristics (ONₙ, Dₙ, GSₙ, Cₙ) may be further used to conduct a search of networked computers, such as the Internet, to identify any web sites/web pages relating to the inputted owner (CN_{INPUT}) and/or the owner (ONₙ) of the trademark matches, and, more specifically, to any product sold under the inputted trademark (TM_{INPUT}) and/or any of the trademark matches (TM₁, TM₂, . . . TMₙ). The inputted product information (PD_{INPUT}) and/or the description of the goods/services (GSₙ) of the trademark matches (TM₁, TM₂, . . . TMₙ) may also be utilized. Again, related-entity information may be searched and used in these searches.

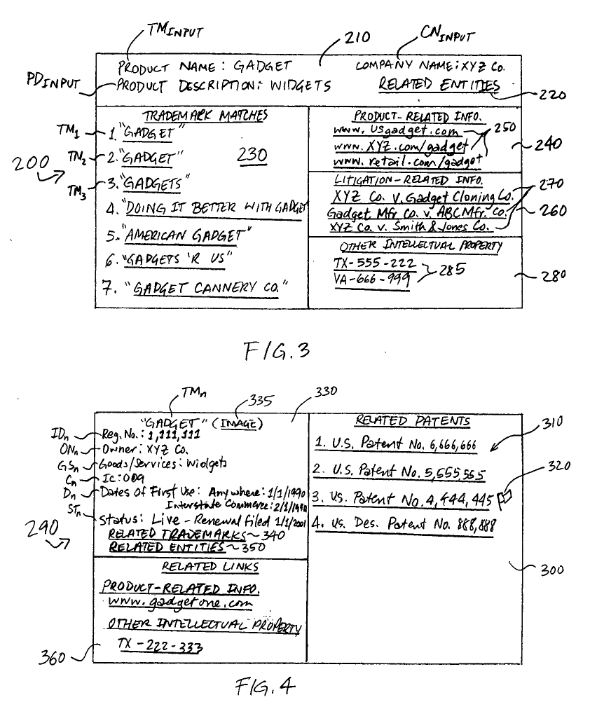

The search results of the method 10 may be presented to the user in any known manner, including using browser-type technology and windows-based formatting. Exemplary presentations of the search results are shown in FIGS. 3-5. As is readily apparent, the search results may be presented in other manners.

With reference to FIG. 3, one or more search results page(s) 200 may be provided which include one or more fields or windows. In a first field 210, the inputted information (TM_{INPUT}; PD_{INPUT}; CN_{INPUT}) may be displayed, along with a link 220 to any related-entity information that has been uncovered based on the inputted information. The related-entity link 220 may be to a separate window (e.g., pop-up) or page which may include varying levels of related-entity information ranging from a brief description of the related-entities to a full-text report about the inputted entity, including financial information (such as a Dun & Bradstreet report). The related-entity link 220 may also include financial information and, optionally, news headlines—in these case(s), additional link(s) and/or different name(s) for the link 220 may be in order, such as “FINANCIAL INFO. & NEWS”.

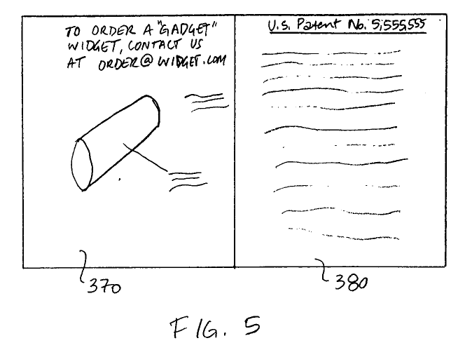

In a second field 230, the trademark matches (TM₁, TM₂, . . . TMₙ) may be listed, preferably in order from most to least relevant, with the most relevant trademark matches being first-presented. For example, as shown in FIG. 3, the trademark matches (TM₁, TM₂, . . . TMₙ) may appear in order from most to least relevant, with only the trademarks themselves being shown. The second field 230 can be navigated using known browser technology, and each trademark match (TM₁, TM₂, . . . TMₙ) may be a link to its associated results in the form of one or more secondary search result pages 290 (FIG. 4), as described below.

In a third field 240, product-related links 250 may be provided to web site(s)/page(s) relating to the inputted information (TM_{INPUT}; PD_{INPUT}; CN_{INPUT}). It is preferred that web site(s)/page(s) be opened in the search results page 200 so that the page 200 is not left from by the browser. Framing technology allows for the web site(s)/page(s) to be opened within the search results page 200.

In a fourth field 260, litigation information related to the inputted information (TM_{INPUT}; PD_{INPUT}; CN_{INPUT}) may be provided, preferably in hierarchical order. The litigation information may be provided as case captions 270 wherein each is a link to a reported decision, to its respective docket sheet (such as that made available over the United States Federal Court System electronic docketing system (PACER)), and/or to other any other related information (such as a Shepard's citation report).

In a fifth field 280, other intellectual property uncovered with respect to the inputted information (TM_{INPUT}; PD_{INPUT}; CN_{INPUT}) may be listed, such as uncovered copyright registrations. The search results may be listed as links 285, with each link being connectable to a record relating to the respective piece of intellectual property. Preferably, the other intellectual property is listed in hierarchical order.

It is preferred that the information displayed in and linked to the search result page 200 be based on, and/or have been uncovered using, the inputted information, and any related entity information.

For each of the trademark matches, and with reference to FIG. 4, a link is provided to a secondary search result page 290 which also includes one or more fields or windows. In a first field 300, the uncovered patents (P₁-P₄) may be listed, preferably, in hierarchical order from most to least relevant. The uncovered patents (P₁-P₄) can appear in the first field 300 as a single navigable list 310 (e.g., navigable using known scrolling functionality) or may be separated in several fields or windows by level of relevance. For example, a window entitled “MOST RELEVANT” could include a listing of the most-relevant patents (e.g., the patents of the results P₄, using the methodology described above), a separate window entitled “SOME RELEVANCE” may include a listing of the second-most relevant patents (e.g., P₃), and so on. Any patents (P₅) uncovered by the fifth query (Q₅) described above or other queries may be listed separately or within the hierarchy.

In the first field 300, basic information regarding each patent may be provided, such as its number, and title (not shown). The patents may each be formed as a link to a separate record, including a full-text version of the patent, bibliographic information, and/or drawings. Flags 320, or other symbols, may be used to quickly-identify a particular characteristic about the patent, such as it being expired, either due to the end of its term and/or failure to pay maintenance fees. Other flags 320 may be used to identify other characteristics, such as post-issuance activity (e.g., certificate of correction; reissuance; reexamination) or litigation history. Links may also be provided from each patent record to related patents (e.g., continuations, divisionals, continuations-in-part, reissues, reexaminations, patents uncovered by the fifth query (Q₅) based on the inventor(s) of the relevant patent); to prior art cited in the relevant patent; to post-issuance activity (certificates of correction; filings for reissues or reexaminations; litigations); and/or, to maintenance fee history.

The secondary search result page 290 may also include a second field or window 330 for the trademark match (TMₙ), along with an identifier (IDₙ) (such as a registration number), associated characteristics (ONₙ, Dₙ, GSₙ, Cₙ), and any other relevant information, such as status information (STₙ). If the trademark match (TMₙ) includes graphical elements (such as a logo), a link 335 may be provided to the image. A link 340 may also be provided as a command to uncover trademarks related to the relevant trademark match (TMₙ). The related trademarks may include trademarks owned by the same owner (ONₙ) and related entities, but not necessarily limited to the same goods/services. Thus, trademarks owned by XYZ Co. can be identified, not limited to trademarks used with widgets. This searching can be done of assignment records in addition to the trademarks databases. The same type of information as described above for the trademarks matches (TM₁, TM₂, . . . TMₙ) can be presented for the related trademark(s).

A related entity link 350 may also be provided if related-entity information had been uncovered relating to the trademark match owner (ONn), even if no patents or other information were uncovered owned by the related entity. As indicated above, the related-entity information can be presented in various forms and may include financial and/or news information. Additional links can be provided for the financial or news information.

Further fields or windows may be provided as needed in the secondary search results page(s) 290, such as auxiliary field or window 360, to contain any additional information uncovered regarding product-related information, litigation-related information, and/or other intellectual property. The product-related information, litigation-related information, and other intellectual property may be presented here in the same manner as discussed above with respect to the search result page 200. The product-related information, litigation-related information, and/or other intellectual property on the secondary search result page 290 may be limited to that information uncovered based on the characteristics (TMₙ, ONₙ, Dₙ, GSₙ, Cₙ) of the relevant trademark match (TMₙ), including related entity information.

As will be appreciated by those skilled in the art, the search results may be provided in any form. It is also desirable to allow an user to open windows of various results for side-by-side comparisons. For example, with reference to FIG. 5, it may be desirable to allow a user to open a certain web page in a field or window 370 side-by-side to a field or window 380 of the text of a patent. In this manner, the patent can be read while viewing product information. Other combinations of fields/windows may be desired. Also, it is preferred that the system allow for particular search results to be flagged as relevant and allowed to be opened as needed. In this manner, a patent uncovered with one trademark match can be viewed side-by-side with a product-related web site uncovered with another trademark match. This flagging can be performed with similar methodology to “favorites” management in a web browser.

By way of non-limiting example, as a result of the above-described processes, a search tool may be developed that responds to a query (e.g., an inputted reference trademark) to achieve a resulting set of related hierarchical data (e.g., patents); related information (e.g., litigation information; copyright registrations); and, specific product information (e.g., framed web page of product; links to related web pages/web sites). As will be recognized by those skilled in the art, the processes described herein can be practiced in other manners. For example, the processes can be used to generally identify the intellectual property owned by a particular party (and, optionally, its related entities). In addition, product-specific intellectual property of the party may be uncovered. For example, widget-related intellectual property of XYZ Co. may be identified.

What is claimed is:

1. A method for investigating intellectual property related to a reference piece of intellectual property, said method comprising:
providing a first database of discrete pieces of first intellectual property, said pieces of first intellectual property each including an associated set of first characteristics;
providing a second database of discrete pieces of second intellectual property, said second intellectual property being of a different type from said first intellectual property;
searching said first database to identify said pieces of first intellectual property having predetermined characteristics in common with the reference piece of intellectual property;
developing at least one query based on at least a portion of said first characteristics of said identified pieces of first intellectual property; and,
searching said second database to identify said pieces of second intellectual property satisfying said at least one query.

2. A method as in claim 1, wherein said pieces of first intellectual property are selected from the group consisting of registered trademarks, unregistered trademarks and applications to register trademarks.

3. A method as in claim 2, wherein said pieces of second intellectual property are selected from the group consisting of patents and patent applications.

4. A method as in claim 3, wherein the reference piece of intellectual property is a trademark.

5. A method as in claim 1, wherein said pieces of second intellectual property are selected from the group consisting of patents and patent applications.

6. A method as in claim 1, wherein the reference piece of intellectual property is a trademark.

7. A method as in claim 1, wherein said step of searching said first database includes searching said first database to identify said pieces of first intellectual property which are identical matches to the reference piece of intellectual property.

8. A method as in claim 1, wherein said step of searching said first database includes searching said first database to identify said pieces of first intellectual property which include at least one term in common with at least a portion of the reference piece of intellectual property.

9. A method as in claim 1 further comprising sorting said identified pieces of first intellectual property.

10. A method as in claim 9, wherein said step of sorting includes comparing each of said identified pieces of first intellectual property with the reference piece of intellectual property to determine degree of similarity therebetween.

11. A method as in claim 1, wherein the steps of developing at least one query and searching said second database are sequentially conducted for each said identified piece of first intellectual property.

12. A method as in claim 11, wherein one of said first characteristics includes the name of the owner of the associated said piece of first intellectual property, and wherein said at least one query includes a first query, said first query being to identify all said pieces of second intellectual property in which the owner of the respective said identified piece of first intellectual property has rights.

13. A method as in claim 12, wherein said first query being to identify all said pieces of second intellectual property in which the owner of the respective said identified piece of first intellectual property has recorder ownership rights.

14. A method as in claim 11, wherein one of said first characteristics includes the goods or services of the associated said piece of first intellectual property, and wherein said at least one query includes a second query, said second query being to identify all said pieces of second intellectual property which relate to the goods or servies of the respective said identified piece of first intellectual property.

15. A method as in claim 11, wherein one of said first characteristics includes information relating to dates of first use of the associated said piece of first intellectual property, and wherein said at least one query includes a third query, said third query being to identify all said pieces of second intellectual property having a filing date or priority date after the dates of first use of the respective said identified piece of first intellectual property.

16. A method as in claim 11, wherein one of said first characteristics includes a classification of the associated said piece of first intellectual property, and wherein said at least one query includes a fourth query, said fourth query being to identify all said pieces of second intellectual property having a classification equivalent to the classification of the respective said identified piece of first intellectual property.
